(19) United States
(12) Patent Application Publication
(10) Pub. No.: US 2007/0226486 A1
(43) Pub. Date: Sep. 27, 2007

(54) TELNET SECURITY SYSTEM AND OPERATION METHOD THEREOF

(75) Inventor: CHIH-LUNG CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,905

(22) Filed: Dec. 28, 2006

(30) Foreign Application Priority Data
Mar. 24, 2006 (TW) 95110337

(51) Int. Cl. H04L 9/00

(52) U.S. Cl. 713/153

(57) ABSTRACT

A telnet security system (100) disposed in a network device (10) includes a detecting module (110) for detecting packets from a user, a network-determining module (120) for determining whether the user is on a valid network, a user-data determining module (130) for determining whether a detected packet from the user on the valid network includes valid user data, a setting-packet determining module (160) for determining whether a detected packet comprising the valid user data is a telnet setting packet, and a function-setting module (170) for setting a telnet function of the network device according to the telnet setting packet. An operation method of the telnet security system used in a network device is also provided.

### BACKGROUND OF THE INVENTION

1. Field of the Invention

The invention relates to telnet security systems, and more particularly to a telnet security system and an operation method thereof.

2. Description of Related Art

Telnet is an application used on the Internet to connect to a remote host computer, enabling access to the remote host computer and its resources. When a telnet connection between a terminal device used by a user and the remote host computer is established, the terminal device emulates a basic terminal and functions as if it was physically connected to the remote host computer, and thus the user has access to all of the publicly available resources, such as library catalogs, databases, etc, stored in the remote host computer. Often, the remote host computer is connected to the terminal device via a network device, such as a router or modem.

However, the network device and the remote host computer, have no powerful security system to prevent access by a hacker or an illegal user based on telnet protocol. If the hacker or the illegal user telnets to the remote host computer or the network device, security problems may occur. The hacker or the illegal user may get or modify important resources in the remote host computer, or modify parameters of the network device.

Therefore, a heretofore unaddressed need exists in the industry to overcome the aforementioned deficiencies and inadequacies.

### SUMMARY OF THE INVENTION

An exemplary embodiment of the invention provides a telnet security system disposed in a network device. The telnet security system includes a detecting module for detecting packets from a user; a network-determining module for determining whether the user is on a valid network; a user-data determining module for determining whether a detected packet from the user on the valid network comprises valid user data; a setting-packet determining module for determining whether a detected packet comprising the valid user data is a telnet setting packet; and a function-setting module for setting a telnet function of the network device according to the telnet setting packet.

Another exemplary embodiment of the invention provides an operation method of a telnet security system used in a network device. The operation method includes steps of: detecting a session request packet from a user; determining whether the user is on a valid network; establishing a session between the user and the network device if the user is on the valid network; detecting a packet from the user on the valid network; determining whether a detected packet comprises encrypted user data; determining whether the encrypted user data is valid if the detected packet comprises encrypted user data; detecting a next packet if the encrypted user data is valid; determining whether a next detected packet is a telnet setting packet; and setting a telnet function of the network device according the next detected packet if the next detected packet is a telnet setting packet.

Other advantages and novel features will become more apparent from the following detailed description when taken in conjunction with the accompanying drawings, in which:

### BRIEF DESCRIPTION OF THE DRAWINGS

FIG. 1 illustrates an application environment of a network device in accordance with an exemplary embodiment of the invention;

FIG. 2 is a block diagram of a telnet security system of the network device of FIG. 1;

FIG. 3 is a flow chart of an operation method of the telnet security system in accordance with another embodiment of the invention; and

FIG. 4 is a flow chart of an operation method of the telnet security system in accordance with still another embodiment of the invention.

### DETAILED DESCRIPTION OF THE INVENTION

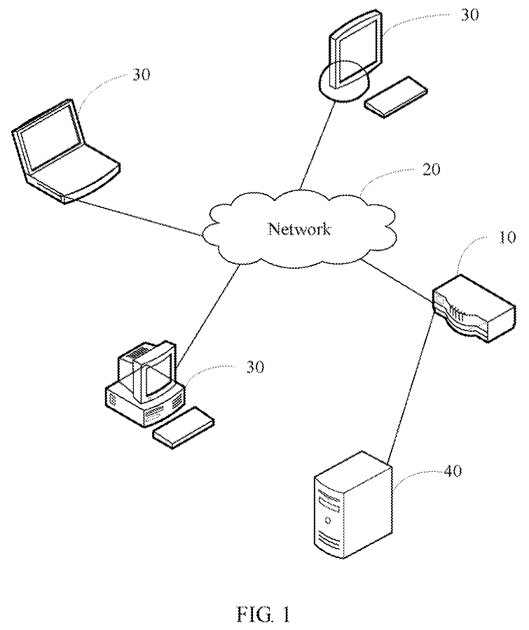

FIG. 1 illustrates an application environment of a network device 10 in accordance with an exemplary embodiment of the invention. A plurality of terminal devices 30 is connected to the network device 10 via a network 20, and communicates with each other via the network 20. The network device 10 also communicates with a remote host computer 40. The terminal device 30 may be a personal computer (PC), a notebook computer or the like. The network device 10 is a router, a switch, a modem or the like. The remote host computer 40 can also be a PC, a notebook computer, a server or the like. The network 20 may be the Internet, an intranet or the like. Particularly, in this exemplary embodiment, the network device 10 is an asymmetric digital subscriber line (ADSL) modem.

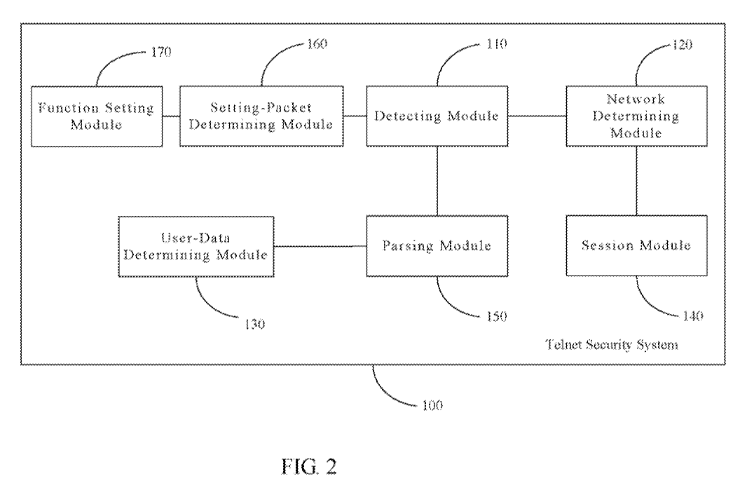

FIG. 2 is a block diagram of a telnet security system 100 of the network of FIG. 1. The telnet security system 100 is disposed in the network device 10, and is used for preventing intrusion by an illegal user based on a telnet protocol. The telnet security system 100 comprises a detecting module 110, a network-determining module 120, a session module 140, a parsing module 150, a user-data determining module 130, a setting-packet determining module 160, and a function-setting module 170. In an alternative embodiment, the telnet security system 100 is disposed in the remote host computer 40.

The detecting module 110 detects packets at a port from a user of the terminal device 30. In this exemplary embodiment, the detected packets comprise session request packets, user data packets, and telnet setting packets and so on. Particularly, the detecting module 110 detects the packets at a port 55600. However, any other ports, for example, 5610 and so on, for detecting the packets can also be employed. The detecting module 110 transmits the detected packet to the network-determining module 120, the parsing module 150, and the setting-packet determining module 160.

The network-determining module 120 determines whether the user is on a valid network. The valid network refers to a network segment, for example, a network segment from 10.1.1.1 to 10.1.1.25, or a subnet, for example, a subnet 10.1.1.0/24, that the telnet security system 100 allows to access. In this exemplary embodiment, the network-determining module 120 checks a source Internet protocol (IP) address of the detected packets from the detecting module 110 and a corresponding subnet mask configured in the network device 10, then figures out a network ID of the user, thereafter compares the network ID with a designated valid network ID stored in the network device 10 so as to determine whether the user is on a valid network. However, in other exemplary embodiments, a network access-list may be employed to determine whether the network ID of the user is valid. If the user is on the valid network, the user is designated as a valid network user.

The session module 140 is used for establishing a session between the network device 10 and the valid network user of the terminal device 30. The session is established according to a three-handshake open network protocol. In this three-handshake process, the session request packet is from the user of the terminal device 30 and is typically designated as a synchronization (“sync”) message. In response to the “sync” message, the network device 10 transmits a synchronization-acknowledgement (“sync-ack”) message. Then the terminal device 30 transmits an acknowledgement (“ack”) message to the network device 10, and a session between the terminal device 30 and the network device 10 is established. In this exemplary embodiment, in order to limit access to the network device 10, the session request packet is checked to determine whether the user of the terminal device 30 transmitting the session request packet is on a valid network. That is, the session is established between the valid network user and the network device 10.

The parsing module 150 parses the detected packet from the detecting module 110 from the valid network user, and determines whether the parsed packet is a user data packet. The user data packet refers to a packet comprising encrypted user data. In this exemplary embodiment, the parsing module 150 checks a payload field of the detected packet from the detecting module 110 to determine whether the user data packet comprises the encrypted user data. In particular, the encrypted user data comprises an encrypted user-name and an encrypted password. The user-name and the password of the user data are encrypted in the user data packet.

The user-data determining module 130 determines whether the user data in the user data packet is valid. In the exemplary embodiment, the user-data determining module 130 compares the encrypted user data in the user data packet from the valid network user with a user data list stored in the network device 10 to check whether the encrypted user data in the user data packet is valid. The user data list comprises a plurality of designated user-names and a plurality of designated passwords corresponding to the user-names. If the encrypted user-name and the encrypted password of the encrypted user data are equal to those of the user data list, the encrypted user data is valid. In another exemplary embodiment, the user data list can be stored in the remote host computer 40, and be transmitted to the network device 10 when necessary. If the encrypted user data is valid, the user is designated as a valid user.

The setting-packet determining module 160 determines whether the detected packet from the detecting module 110 from the valid user is a telnet setting packet. In this exemplary embodiment, the setting-packet determining module 160 checks a payload field of the detected packet from the detecting module 110 to determine if the packet is a telnet setting packet. The telnet setting packet comprises a telnet enabling packet and a telnet disabling packet.

The function-setting module 170 sets a telnet function of the network device 10 according to the telnet setting packet. In the exemplary embodiment, the setting of the telnet function of the network device 10 refers to enabling or disabling the telnet function of the network device 10 according to the telnet setting packet. That is, if the telnet setting packet is a telnet enabling packet, the function-setting module 170 enables the telnet function of the network device 10, thus valid users can telnet to the network device 10 or telnet to the remote host computer 40 via the network device 10. And if the telnet setting packet is a telnet disabling packet, the function-setting module 170 disables the telnet function of the network device 10, thus valid users cannot telnet to the network device 10 or telnet to the remote host computer 40 via the network device 10.

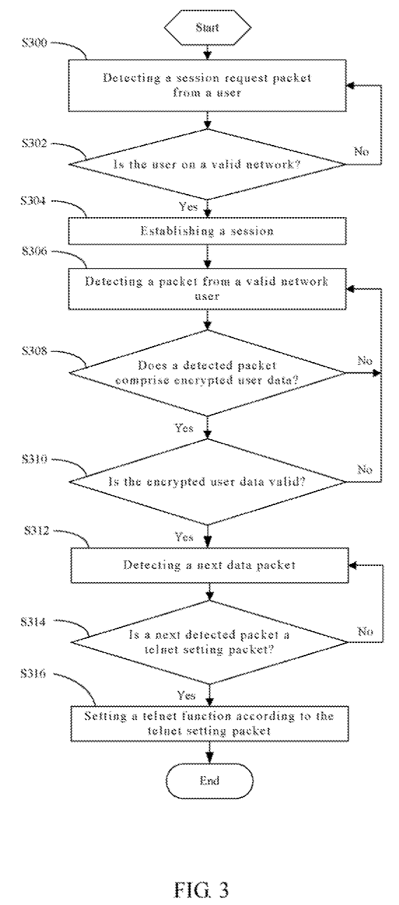

FIG. 3 is a flow chart of an operation method of the telnet security system 100 in accordance with another embodiment of the invention.

In step S300, the detecting module 110 detects a session request packet from a user of the terminal device 30 for requesting to establish a session between the network device 10 and the terminal device 30. After the session request packet is detected, the process proceeds to step S302.

In step S302, the network-determining module 120 determines whether the user is on a valid network. If the user is on a valid network, herein, the user is designated as a valid network user, the process proceeds to step S304. If the user is not on a valid network, the process returns to step S300 to detect another session request packet from another user.

In step S304, the session module 140 establishes a session between the valid network user of the terminal device 30 and the network device 10. The process then proceeds to step S306.

In step S306, the detecting module 110 detects a packet from the valid network user. Then the process proceeds to step S308.

In step S308, the parsing module 150 parses the detected packet and determines whether the parsed packet comprises encrypted user data comprising a user-name and a password. If the detected packet comprises an encrypted user-name and an encrypted password, the process proceeds to step S310. If the detected packet does not comprise the encrypted user-name and the encrypted password, the process returns to step S308 to detect another packet.

In step S310, the user-data determining module 130 determines whether the encrypted user data is valid according to a user data list stored in the network device 10. The user data list comprises a plurality of designated user-names and a plurality of designated passwords corresponding to the user-names respectively. If the user data is valid, herein the user is designated as a valid user, the process proceeds to step S312. If the user data is not valid, the process returns to step S306.

In step S312, the detecting module 110 continues on to detect a next packet from the valid user, then the process proceeds to step S314.

In step S314, the setting-packet determining module 160 determines whether the next detected packet is a telnet setting packet. If the next detected packet is a telnet setting packet, the process proceeds to S316. If the next detected packet is not a telnet setting packet, the process returns to S312 to detect another next packet.

In step S316, the function-setting module 170 sets a telnet function according to the telnet setting packet.

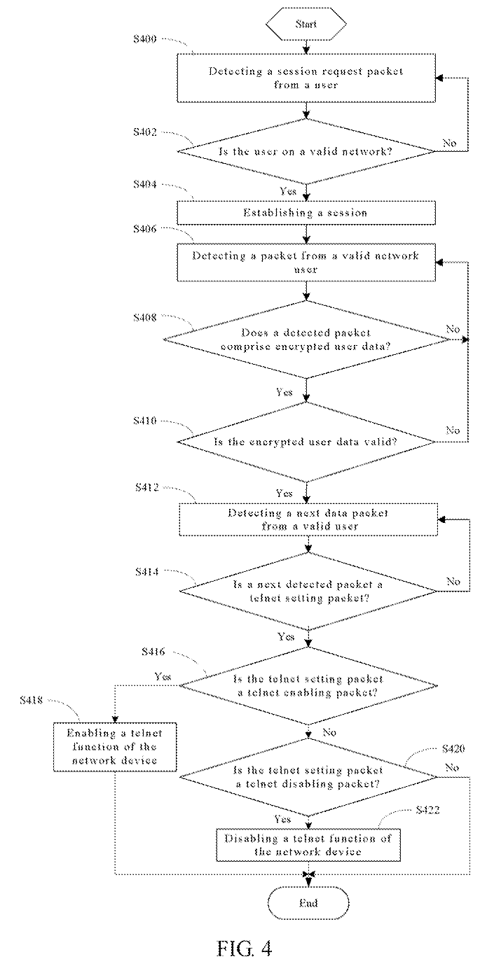

FIG. 4 is a flow chart of an operation method of the telnet security system 100 in accordance with still another embodiment of the invention.

In this exemplary embodiment, the steps from step S400 to step 412 are respectively the same as the steps from step 300 to step 312 described above, herein the steps 400, 402, 404, 406, 408, 410 and 412 are not described.

In step S414, the setting-packet determining module 160 determines whether the next detected packet is a telnet setting packet. If the next detected packet is a telnet setting packet, the process proceeds to S416. If the next detected packet is not a telnet setting packet, the process returns to S412 to detect another next packet.

In step S416, the function-setting module 170 determines whether the telnet setting packet is a telnet enabling packet. If so, the process then proceeds to step S418.

In step S418, the function-setting module 170 enables a telnet function of the network device 10.

If the telnet setting packet is not a telnet enabling packet, the process then proceeds to step S420, where the function-setting module 170 determines whether the telnet setting packet is a telnet disabling packet. If so, the process then proceeds to step S422.

In step S422, the function-setting module 170 disables the telnet function of the network device 10. If the telnet setting packet is not a telnet disabling packet, the process directly proceeds to the end.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A telnet security system disposed in a network device, the telnet security system comprising:
a detecting module for detecting packets from a user;
a network-determining module for determining whether the user is on a valid network;
a user-data determining module for determining whether a detected packet from the user on the valid network comprises valid user data;
a setting-packet determining module for determining whether a detected packet comprising valid user data is a telnet setting packet; and
a function-setting module for setting a telnet function of the network device according to the telnet setting packet.

2. The telnet security system according to claim 1, further comprising a parsing module for parsing the detected packet from the valid network and determining whether a parsed packet comprises encrypted user data.

3. The telnet security system according to claim 2, wherein the parsing module parses a payload of the detected packet from the valid network to determine whether the parsed packet comprises encrypted user data.

4. The telnet security system according to claim 2, wherein the encrypted user data comprises an encrypted user-name and an encrypted password.

5. The telnet security system according to claim 4, further comprising a user data list comprising a plurality of designated user-names and a plurality of designated passwords corresponding to the user-names respectively.

6. The telnet security system according to claim 5, wherein the user-data determining module compares the encrypted user data with the user data list to check whether the encrypted user data is valid.

7. The telnet security system according to claim 1, further comprising a session module for establishing a session between a user on the valid network and the network device.

8. The telnet security system according to claim 1, wherein the telnet setting packet comprises a telnet enabling packet for enabling the telnet function of the network device.

9. The telnet security system according to claim 1, wherein the telnet setting packet further comprises a telnet disabling packet for disabling the telnet function of the network device.

10. An operation method of a telnet security system used in a network device, comprising:
detecting a session request packet from a user;
determining whether the user is on a valid network;
establishing a session between the user and the network device if the user is on the valid network;
detecting a packet from the user on the valid network;
determining whether a detected packet comprises encrypted user data;
determining whether the encrypted user data is valid if the detected packet comprises encrypted user data;
detecting a next packet if the encrypted user data is valid;
determining whether a next detected packet is a telnet setting packet; and
setting a telnet function of the network device according to the next detected packet if the next detected packet is a telnet setting packet.

11. The operation method according to claim 10, wherein the step of determining whether the detected packet comprises encrypted user data comprises:
parsing a user data packet; and
determining whether the parsed user data packet comprises encrypted user data.

12. The method according to claim 10, wherein the step of setting the telnet function of the network device according the data packet if the data packet is a telnet setting packet comprises:
determining whether the telnet setting packet is a telnet enabling packet; and
enabling the telnet function of the network device if the telnet setting packet is a telnet enabling packet;

13. The method according to claim 10, wherein the step of setting the telnet function of the network device according to the data packet if the data packet is a telnet setting packet further comprises:
determining whether the telnet setting packet is a telnet disabling packet; and
disabling the telnet function of the network device if the telnet setting packet is a telnet disabling packet.

14. A method for providing secure telnet operation in a network device, comprising steps of:
detecting a session request packet from a user;
determining whether said user is in a valid network for said network device according to said session request packet;
establishing a session between said user and said network device when said user is in a valid network;
detecting a next packet from said user;
determining whether said detected next packet comprises valid user data; and
enabling a telnet operation function of said network device for said user when said detected next packet comprises valid user data.

15. The method according to claim 14, wherein said telnet operation function of said network device is enabled for said user according to a telnet setting packet from said user.
